(19) United States
(12) Patent Application Publication
(10) Pub. No.: US 2008/0066790 A1
(43) Pub. Date: Mar. 20, 2008

(54) Autonomous Personal Vehicle Washing and Drying System

(76) Inventor: Brian J. Rems, Palm Beach Gardens, FL (US)

Correspondence Address: DARBY & DARBY (formerly Sacco & Associates), P.O. BOX 770, CHURCH STREET STATION, NEW YORK, NY, 10008-0770, US

(21) Appl. No.: 11/533,534

(22) Filed: Sep. 20, 2006

(51) Int. Cl. B08B 3/00; B08B 3/04; B08B 3/12

(52) U.S. Cl. 134/123; 134/56 R; 134/198; 134/172

(57) ABSTRACT

An autonomous vehicle washing and drying apparatus (10) that is truly portable, easily stored, and capable of fully independent and automatic operation. The apparatus (10) is self-contained and requires no connection to a water or power source. One or more tanks (175) hold the necessary water, detergent and automotive chemicals used for washing the exterior surface of the vehicle (A). A power source such as a battery (250), fuel cell, or electrical energy generated by an onboard electrical generator powered by a gasoline, ethanol, or hybrid engine provides electrical power for the various electrical components that comprise the apparatus. One or more sensors (210, 212) constantly determine the distance of the apparatus (10) in relation to the vehicle (A). The one or more sensors (210, 212) provide the distance information to an electronic control system (200) for guiding the movement of the apparatus (10) on a circumferential path (P) around the vehicle. The apparatus (10) can also dry the vehicle (A) in a manner similar to the washing operation.

### BACKGROUND OF THE INVENTION

1. Statement of the Technical Field

The invention relates to an apparatus for washing and drying vehicles. More particularly, this invention relates to a personal, self-contained and autonomous vehicle washing and drying system.

2. Description of the Related Art

Vehicle washes and systems for washing vehicles are well known in the art. Typically, such systems are commercial in nature and not intended for personal use. These systems usually involve an arrangement of pumps, one or more movable sprayer heads and/or sprayer arms, tanks for detergents and waxes, and a bay wherein the arrangement is fixated so that the washing operation is directed towards washing the vehicle within the bay. More recent improvements to these arrangements include the use of sensors and electronic controls for guiding the operation of the sprayer arms and sprayer heads in relation to the vehicle.

Also known in the art are portable vehicle washing and cleaning systems that are intended for personal use, such as at home on the driveway. These arrangements enable vehicle owners to more conveniently wash their vehicles without going to a car wash. This can save both time and money. For example, in U.S. Pat. No. 5,638,843, there is provided a portable, collapsible car wash shower which includes an overhead conduit extending between a pair of vertical conduits such that a vehicle can be driven between and beneath the conduits. A plurality of spray nozzles project interiorly from the conduits to spray water onto the associated vehicle. The conduits are connected together by selectively flexible corner couplings which permit the conduits to be selectively pivoted into a parallel orientation for storage.

In U.S. Pat. No. 6,766,966, a portable, battery powered spray applicator car wash device capable of holding and dispensing liquid cleansers and waxes for rubbing into the body and windows of a vehicle is shown; enabling complete and portable mobile washing and cleaning services and complete detailing of a vehicle without the use of water.

U.S. patent application Ser. No. 2005/0133071A1 discloses an apparatus designed for washing cars in a casual environment, such as outside a residential home, by a homeowner or other untrained user. The apparatus is easily transportable, for instance, from a garage into the driveway or street, and is easily stowed. The apparatus is also self-propelled, and remotely controlled.

However, one drawback to the home car washing devices known in the art is that the vehicle owner is required to be involved in the cleaning and washing operation, at least at some level. Another drawback to some of the known home car washing devices is that an overhead arm is utilized for holding and positioning the sprayer heads over the top of the vehicle. The overhead arms make these devices bulky and hard to store. The use of multiple sprayer heads substantially reduces the amount of fluid pressure available to each of the sprayer heads diminishing the overall cleaning effectiveness of the device. Additionally, no other device known in the art delivers a heated fluid source or provides the capability of drying the surface of the vehicle after the vehicle has been washed.

Still another drawback is that some of these devices are required to be connected to a source of water or power which limits the portability and operation of the device. Specifically, if the device is connected to a source of water or power then the device is not free to completely move around the perimeter of the vehicle during the washing operation. Further, the tethered water and power connections would preclude the device from being a truly portable and automatic washing and cleaning system which is capable of being used virtually anywhere.

In view of the forgoing, there remains a need for an improved vehicle washing and drying system that is truly portable, effective, easily stored, and capable of fully independent and automatic operation. The system must be self-contained requiring no operating power or tethered water source connections, self-directing around the perimeter of a vehicle, and fully automatic with respect to the washing and drying cycles performed on the vehicle. The present invention fulfills this need by providing a self-contained, self-guided autonomous vehicle washing system capable of independent movement around a vehicle for washing and drying a vehicle.

### SUMMARY OF THE INVENTION

An autonomous vehicle washing and drying apparatus that is portable, easily stored, and capable of fully independent and automatic operation is provided. In one embodiment of the invention, the apparatus is comprised of a motorized base portion, a surface treating system mounted on the motorized base portion for washing and drying the exterior surface of the vehicle, and an electronic control system for autonomously guiding the motorized base portion on a circumferential path around the vehicle. The surface treating system includes at least one spray head delivering pressurized cleaning fluid to the exterior surface of the vehicle as the apparatus moves along the circumferential path around the vehicle.

The at least one spray head moves back and forth along a track comprised of a vertical portion, an arcuate portion, and a horizontal portion. The spray head delivers pressurized cleaning fluid to the vertical surfaces of the vehicle as the spray head moves back and forth along the vertical portion of the track. The horizontal portion of the track is varied in height by a spherical guide member disposed on a distal end of the horizontal portion. The spherical guide member is configured to be disposed on horizontal surfaces of the vehicle. The spherical guide member urges against the horizontal surfaces causing the height of the horizontal portion to conform to the varying heights of the horizontal surfaces of the vehicle. The horizontal portion of the track supports the spray head over the horizontal surfaces as the spray head delivers pressurized cleaning fluid to the horizontal surfaces.

The at least one spray head is movably mounted on the track by a pair of guide rollers. At least one of the guide rollers is motorized by an electric motor for propelling the spray head back and forth along the track. The pair of guide rollers allows the spray head to seamlessly transition between the vertical portion, arcuate portion, and horizontal portion of the track. In addition, the spray head can direct pressurized air to the exterior surface of the vehicle for drying the vehicle.

The electronic control system includes at least one sensor for continuously determining distance information between the motorized base portion and the vehicle. The electronic control system uses the distance information to provide error correcting signals to the motorized base portion to maintain the motorized base portion a predetermined distance from the vehicle as the motorized base portion is propelled on the circumferential path. In one embodiment of the invention, the predetermined distance is twelve inches.

The motorized base portion includes at least one wheel for steering the motorized base portion along the circumferential path. The at least one wheel is steered by a servomotor receiving the error correcting signals from the electronic control system. The motorized base portion further includes at least one wheel for propelling the motorized base portion on the circumferential path. The at least one wheel is provided rotary power by an electric motor.

The apparatus is powered by a power source. In one embodiment of the invention, the power source is a rechargeable battery. In other embodiments of the invention, the power source is a fuel cell or an onboard electrical generator. The electrical generator is supplied rotary power by an engine fueled by gasoline, ethanol, or a hybrid engine powered by gasoline and ethanol.

There are one or more tanks for storing at least one fluid used in conjunction with the surface treating system. The at least one fluid is pressurized by a pump for delivering the fluid to the spray head. The at least one fluid in the one or more tanks is pre-heated by a pre-heater which is energized prior to the apparatus being used.

### BRIEF DESCRIPTION OF THE DRAWINGS

Embodiments will be described with reference to the following drawing figures, in which like numerals represent like items throughout the figures, and in which:

FIG. 1 is a perspective view of an autonomous vehicle washing apparatus that is useful for understanding the invention.

FIG. 2 is another perspective view of the apparatus of FIG. 1 showing its intended use for washing a vehicle.

FIG. 3 is an elevated side view of the apparatus of FIG. 1 showing its intended use for washing a vehicle.

FIG. 4 is an elevated front view of the apparatus of FIG. 1.

FIG. 5 is a cross-sectional view of the apparatus of FIG. 1 along line 5-5 of FIG. 4.

FIG. 6 is a schematic diagram of an electronic control system for the apparatus of FIG. 1.

### DETAILED DESCRIPTION OF THE PREFERRED EMBODIMENTS

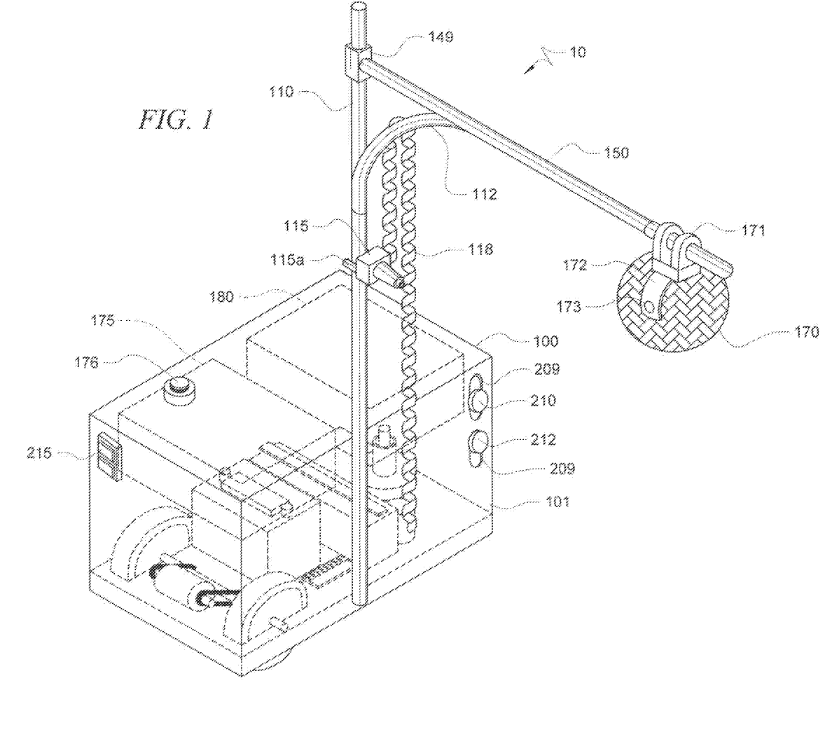

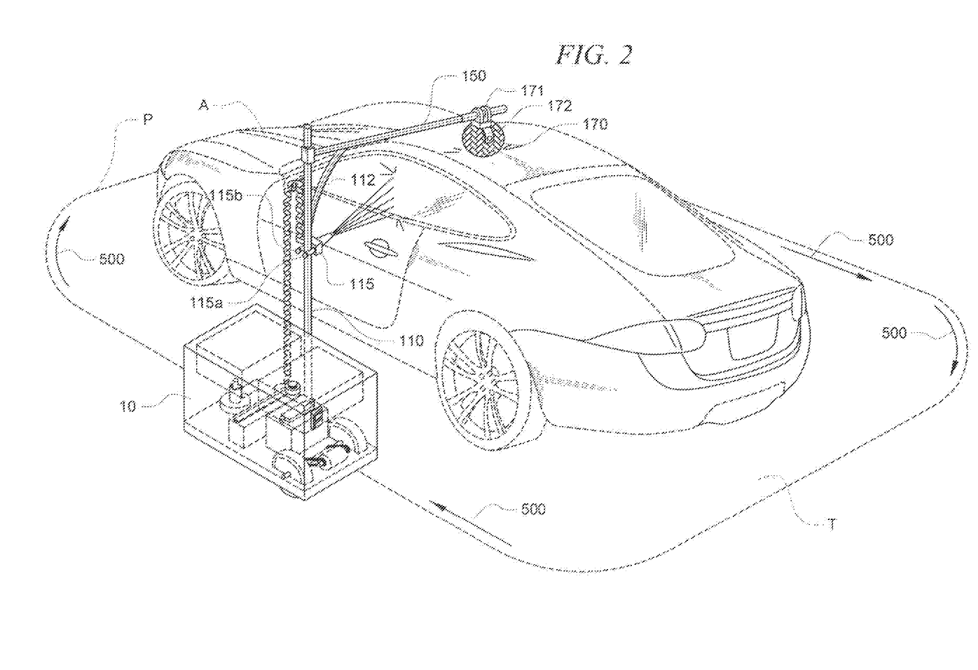

Referring to FIGS. 1 and 2, shown is a perspective view of an autonomous vehicle washing and drying unit 10 and its intended use with a vehicle that is useful for understanding the invention. In one embodiment of the invention, the vehicle A to be washed and dried is an automobile. However, the invention is not limited in this regard in that the unit 10 can be configured and used to wash and dry other items or vehicles such as motorcycles, trucks, buses, recreational vehicles, and airplanes. The unit 10 is comprised of a mobile base portion 100 partially formed of a housing 101 containing some of the operational components of the invention. The washing unit 10 can be used anywhere there is a large enough area so that a vehicle A can be located in a target area T and the washing unit 10 can move around the vehicle A in a circumferential path P. Typically, a washing unit 10 would be utilized on a driveway but this is not meant to be limiting. Other places where the unit 10 can be used for washing a vehicle A includes parking lots and larger garages.

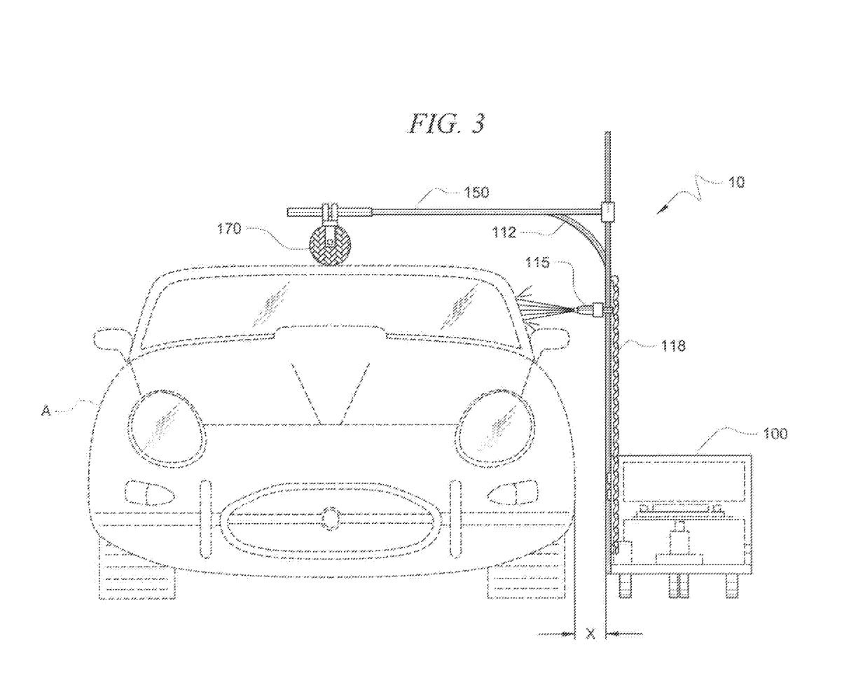

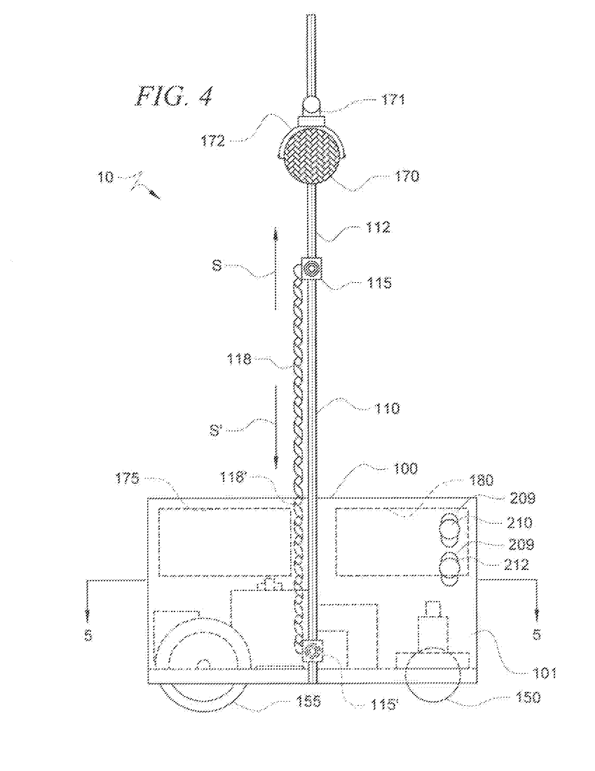

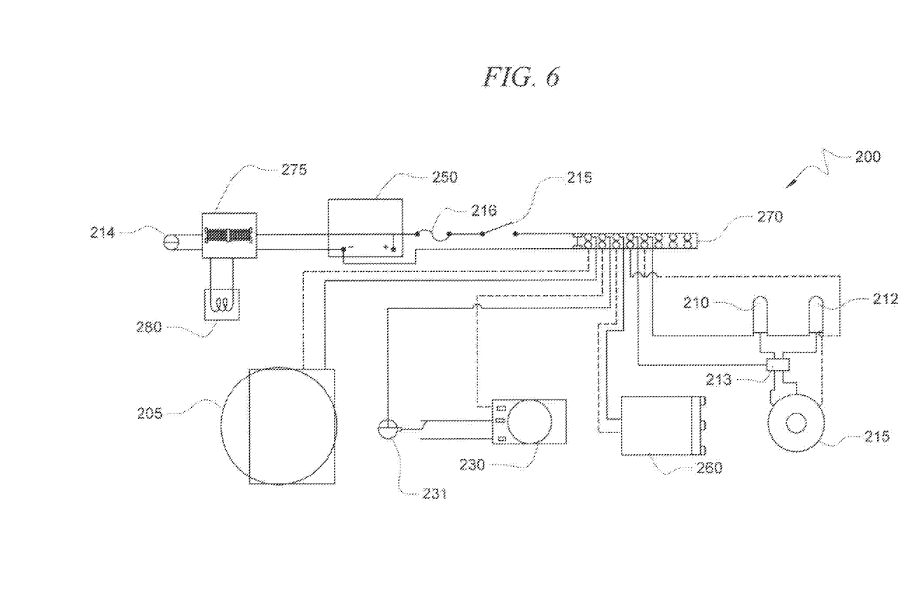

An electronic control system 200 (FIG. 6) is located in base portion 100 which when used in conjunction with a pair of positioning sensors 210, 212 (see also FIG. 4), guides the unit 10 relative to the vehicle A being washed by staying a predetermined distance X (FIG. 3) from the vehicle A. In one embodiment of the invention, the distance X is twelve inches. However, the invention is not limited in this regard as other predetermined distances could be selected according to user preference. The unit 10 has a spray head 115 movably mounted on a track comprised partially of a post 110, an arcuate track portion 112, and a guide arm 150 (hereinafter “track”) for directing a high pressure jet of cleaning spray onto the exterior surfaces of vehicle A. The post 110 extends upwardly from the base portion 100. The spray head 115 is mounted to post 110, arcuate track portion 112, and guide arm 150 with a pair of resilient rollers 115a, 115b that extend from the rear of spray head 115. The rollers 115a, 115b are made from a material that is resilient but also has a high coefficient of friction. The rollers 115a, 115b are mounted on the rear of spray head 115 in an opposing configuration for receiving therebetween the respective portions of the track. The rollers 115a, 115b are concave towards the center to form a recess wherein the respective portions of the track are received. The rollers 115a, 115b grip the post 110, arcuate track portion 112, and guide are 150 therebetween for supporting spray head 115. One of the rollers 115a is provided rotary power from an electric motor 230 (FIG. 6). The other roller 115b is mounted on a spindle (not shown) and is free to rotate as spray head 115 moves back and forth along the track. The motorized roller 115a urges against the respective track portions and due to the high friction between motorized roller 115a and the respective tract portions, spray head 115 is propelled along the post 110, arcuate track portion 112, and the guide arm 150.

The guide arm 150 is movably mounted on post 110 by a sliding bracket 149. The arcuate track portion 112 transitions rollers 115a, 115b from the post 110 to the guide arm 150 as spray head 115 moves back and forth along the resulting track. The arcuate track portion 112 moves concurrently along post 110 with the guide arm 150 as the guide arm 150 moves vertically as discussed below. At least a portion of the arcuate track portion 112 partially surrounds the post 110 and extends in the same longitudinal direction. This portion of arcuate track portion 112 attaches one end of arcuate track portion 112 to post 110 while allowing arcuate track portion 112 to move relative thereto. The arcuate track portion 112 assures a seamless transition of spray head 115 as spray head 115 moves from the post 110 to the guide arm 150 as spray head 115 moves back and forth along the track.

The guide arm 150 has a spherical guide member 170 at the distal end which engages the horizontal surfaces of vehicle A (best seen in FIG. 3). The spherical guide member 170 is mounted to the guide arm 150 with a frame member 172 and a mounting member 171. The spherical guide member 170 is rollably mounted to frame member 172 with an axle 173. The frame member 172 is mounted on a spindle (not shown) on mounting member 171 and is free to rotate about the spindle (not shown). The spherical guide member 150 is made from a resilient material having a high coefficient of friction and has a texture mimicking a tire tread. The resilient material prevents scratching and marring of the vehicle A exterior surfaces.

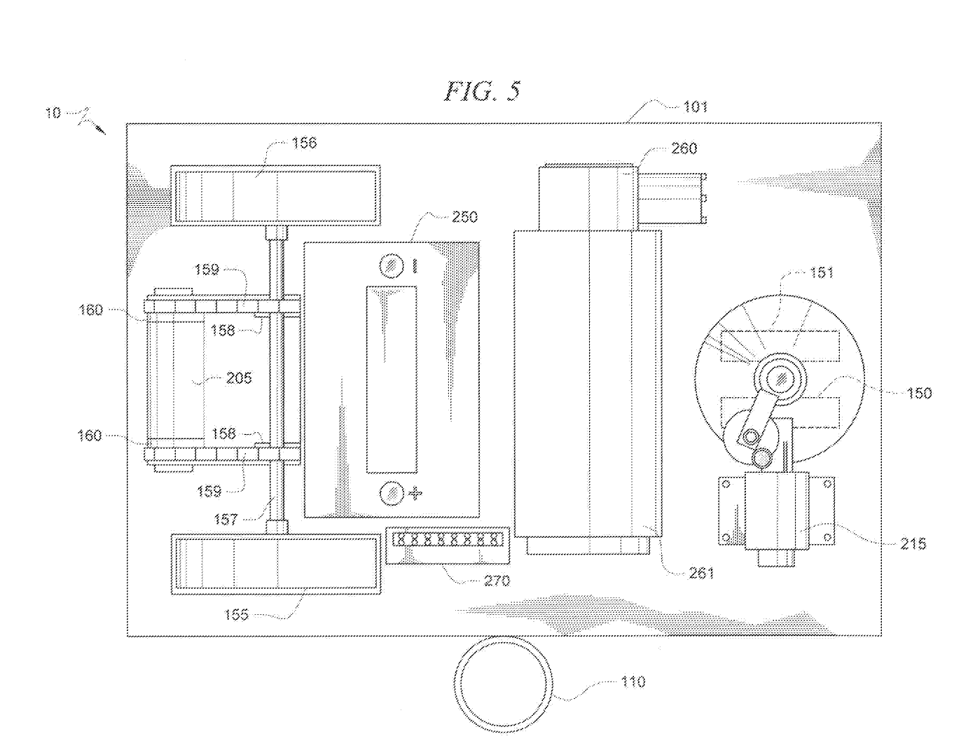

The guide arm 150 is for guiding the spray head 115 over the varying height horizontal surfaces of the vehicle A including the roof, hood and trunk. For example, as the unit 10 moves from a position adjacent the roof of the vehicle A in FIG. 2 to a position adjacent the hood (not shown), the guide arm 150 guided by the spherical member 170 will follow the contour of the vehicle A so that the guide arm 150 will be lowered by gravity to a position just above the hood of the vehicle A. In this manner, as the spray head 115 traverses back and forth along the guide arm 150 (discussed in more detail below), cleaning spray from spray head 115 is directed onto the hood of the vehicle A. The cleaning spray is delivered to spray head 115 from a cleaning fluid tank 175 pressurized by a pump 260 (FIGS. 5 and 6). Oppositely, when the unit 10 moves from a position adjacent the hood (not shown) of vehicle A to a position adjacent the roof (FIG. 2) of vehicle A, the guide arm 150 guided by spherical member 170 will follow the contour of the vehicle A so that the guide arm 150 is urged upward by spherical member 170 to a position just above the roof of vehicle A. Thus, as the spray head 115 traverses back and forth along guide arm 150, cleaning spray from spray head 115 is directed onto the roof of vehicle A. Similarly, cleaning spray is directed to the vertical surfaces of the vehicle A as spray head moves back and forth along the portion of the track comprised of post 110.

In performing the washing and drying operation, the unit 10 moves relative to the vehicle along a circumferential path P around vehicle A such that one complete washing or drying cycle is completed during one complete revolution around vehicle A. In one embodiment of the invention, the unit 10 moves in a clockwise circumferential path P around the vehicle A. Arrows 500 show the direction of movement of unit 10 around vehicle A. The unit 10 moves at a speed such that is takes approximately ten minutes to perform one complete revolution and washing cycle or drying around vehicle A. Although the unit 10 may be configured to move at differing speeds around vehicle A, a cycle time of approximately ten minutes has been found to be optimal to perform each of the washing and drying operations considering the amount of cleaning fluid available onboard as well as available power from a rechargeable battery 250 power source (FIG. 5).

Still referring to FIGS. 1 and 2, and also now to FIG. 3, in use the unit 10 is initially placed a distance X from the vehicle A. The unit 10 can initially be placed at any position adjacent the vehicle A at the distance X. The guide arm 150 is positioned over the adjacent horizontal surface of the vehicle A so that the spherical guide member 170 at the distal end engages the horizontal surfaces of vehicle A. The power switch 215 is then switched to the on position. A propulsion drive motor 205 (FIGS. 5 and 6) driving a pair of drive wheels 155, 156 (FIG. 5) then begins to propel the unit 10 in a clockwise direction along the circumferential path P around vehicle A. A pair of position sensors 210, 212 continually monitors the distance between the unit 10 and vehicle A to maintain the distance X. If the unit 10 comes closer to vehicle A than the distance X, the electronic control system 200 (FIG. 6) sends an electrical signal to a servomotor 215 (FIGS. 5 and 6) to steer a pair of steering wheels 150, 151 (FIG. 5) to the left to cause the unit 10 to open the distance to vehicle A. The unit 10 is steered to the left until the sensors 210, 212 detect that the unit 10 is again at a distance greater than distance X. When the sensors 210, 212 detect the unit 10 is again at distance X, within a predetermined amount of error, an electrical signal is sent to the servomotor 215 (FIGS. 5 and 6) to causes the steering wheels 150, 151 to straighten so that the unit 10 again follows the circumferential path P. The sensors 210, 212 are mounted to housing 101 in slots 109 (see also FIG. 4) so that sensors 210, 212 can be adjusted vertically for vehicles of different sizes.

Similarly, if the unit 10 moves farther from vehicle A than distance X, the electronic control system 200 (FIG. 6) sends an electrical signal to a servomotor 215 (FIGS. 5 and 6) to steer the steering wheels 150, 151 to the right to cause the unit 10 to close the distance to vehicle A to distance X. The sensors 210, 212 also cause the unit 10 to be steered around the four corners of vehicle A by sensing when the unit 10 moves outside of the distance X along circumferential path P. The servomotor 215 (FIGS. 5 and 6) then steers the steering wheels 150, 151 (FIG. 5) left or right until the unit 10 is again at distance X. For example, when the unit 10 must turn around the front left corner of the vehicle A, the servomotor 215 (FIGS. 5 and 6) must cause steering wheels 150, 151 to turn to the right. This cannot occur until the unit 10 moves past the front end of the vehicle A and the sensors 210, 212 detect that the unit 10 has moved a distance greater than distance X from the vehicle A. When this occurs, servomotor 215 (FIGS. 5 and 6) then causes steering wheels 150, 151 to be steered to the right until unit 10 moves within distance X. This cycle is repeated as the unit 10 moves along the circumferential path P and must maneuver around each of the remaining three corners of vehicle A.

When the wash cycle is completed by the unit 10 completing one complete revolution around vehicle A, the user can move the power switch 215 to the off position and the unit 10 can then be returned to storage. The rechargeable battery 250 (FIGS. 5 and 6) can be recharged and the cleaning fluid supply tank 175 can be refilled with cleaning fluid. Alternately, the unit 10 could be set to perform a drying operation by again switching power switch 215 to the on position and letting the unit 10 again circumscribe the vehicle A. However, this can only be done if the cleaning fluid in cleaning fluid supply tank 175 has been exhausted during the wash cycle. When the cleaning fluid in cleaning fluid supply tank 175 has been exhausted, pump 260 (FIGS. 5 and 6) will function as a blower and direct a blast of high pressure air through spray head 115 onto the exterior surfaces of vehicle A for drying. Pump 260 (FIGS. 5 and 6) is a positive displacement type pump which can run dry for over an hour. For example, a Hydra-Cell F/G-20 Series pump is one positive displacement pump that could be used. The Hydra-Cell F/G-20 Series pump is available from Wanner Engineering, Inc. of Minneapolis, Minn. The unit 10 can be allowed to circumscribe the vehicle A until the power in battery 250 (FIGS. 5 and 6) is exhausted or power switch 215 is moved to the off position by the user.

During the wash cycle, spray head 115 moves back and forth along the track partially formed from the post 110 that extends upwardly from the base portion 100. As discussed, a portion of the track also comprises a portion of guide arm 150 so that spray head 115 is moved back and forth over the horizontal surfaces of the vehicle A. In one embodiment of the invention, an electric motor 230 (FIGS. 5 and 6) integrally mounted with spray head 115 causes spray head 115 to move back and forth along the track when the power switch 215 is moved to the on position. In this manner, spray head 115 moves back and forth along a path extending from the lower end of post 110 to a point adjacent the spherical guide member 170 on the distal end of guide arm 150. A relay switch 231 (FIGS. 5 and 6) located in spray head 115 could be used to cause the electric motor 230 (FIGS. 5 and 6) propelling spray head 115 to reverse directions when the spray head 115 reaches the lower end of post 110 or the most distal point on guide arm 150. The relay switch 231 (FIGS. 5 and 6) could reverse the direction of the electric motor 230 (FIGS. 5 and 6) by engaging projections (not shown) located at the lower end of post 110 and the most distal point of travel on guide arm 150. Still, the invention is not limited in this regard. Alternately, the relay switch 231 (FIGS. 5 and 6) in spray head 115 could reverse the direction of the electric motor 230 (FIGS. 5 and 6) with the use of sensors located at the lower end of post 110 and the most distal point on guide arm 150.

In another embodiment of the invention, an arrangement of belts and pulleys (not shown) could be used to move spray head 115 back and forth along track. In this arrangement, an electric motor (not shown) would be mounted in housing 101 for providing rotary power to the arrangement of belts (not shown) moving spray head 115 back and forth over the track. A switch (not shown) on spray head 115 could be used to cause the electric motor (not shown) propelling spray head 115 to reverse directions when the spray head 115 reaches the lower end of post 110 or the most distal point on guide arm 150. The switch (not shown) could reverse the direction of the electric motor (not shown) with the use of projections or sensors located at the lower end of post 110 and the most distal point of travel on guide arm 150.

The path of travel for spray head 115 is designed so that all of the exterior surfaces of vehicle A will receive a jet of cleaning spray in an overlapping pattern during the wash cycle. For example, as the spray head 115 moves from the lowest position along the tract at the lower end of post 110 upwards, the vertical exterior surfaces of vehicle A are washed. As the spray head 115 reaches the highest point on the exterior vertical surfaces of vehicle A, spray head 115 is caused to begin a ninety-degree turn along the arcuate portion 112 of the track. As spray head 115 continues along the track to the arcuate portion 112, spray head 115 is guided on to guide arm 150 to the distal end of guide arm 150. The distal end of the guide arm 150 extends to the approximate centerline of vehicle A. Thus, a jet of cleaning spray from spray head 115 is directed onto the exterior horizontal surfaces of vehicle A. Accordingly, the entire exterior surface of vehicle A is systematically washed by a high pressure jet of cleaning fluid from spray head 115 as the unit 10 moves in one complete revolution around vehicle A.

The unit 10 is completely self-contained and requires no tethered connection to an external source of power of source of cleaning fluid such as water. In one embodiment of the invention, there is a rechargeable battery 250 (FIGS. 5 and 6) for providing electrical power. Prior to use, the battery 250 (FIGS. 5 and 6) must be charged, a process which requires the unit 10 be connected to a source of electrical power. An electrical cord and plug (not shown) could be provided for this purpose. The battery 250 (FIGS. 5 and 6) could be a twelve volt automotive or marine type battery for supplying electrical power to the electronic control system 200 (FIG. 6), pump 260 (FIGS. 5 and 6), servomotor 215 (FIGS. 5 and 6), propulsion motor 205 (FIGS. 5 and 6), sensors 210, 212 and spray head motor 230 (FIGS. 5 and 6). After use, the battery 250 (FIGS. 5 and 6) must again be recharged by being connected to a source of electrical power such as conventional 120 vac household current. Alternately, the unit 10 could be equipped with a power generating unit 180 (not shown) which could include a fuel cell or a conventional electrical generator (not shown). The electrical generator (not shown) could be provided with rotary power by a prime mover such as an engine fueled by gasoline or ethanol, or a hybrid thereof. Alternately, a hybrid of the battery 250 (FIGS. 5 and 6) and the power generating unit 180 could be used to supply the necessary electrical power.

In one embodiment of the invention, there is a cleaning fluid tank 175 for storing cleaning fluid such as water used during the washing cycle. It has been found that a cleaning fluid tank 175 having a capacity of ten gallons (U.S.) is optimal for a washing cycle of approximately ten minutes. The cleaning fluid from cleaning fluid tank 175 is highly controlled and delivered under pressure to spray head 115 by pump 260 (FIGS. 5 and 6). For example, it has been observed that the ten gallons of water from cleaning fluid tank 175 can be delivered to spray head 115 at a pressure of 1500 psi at a rate of 1 GPM. This is in contrast to the sixty to ninety gallons of water typically required to wash an automobile at home by hand washing. When empty, a filler cap 176 is provided for refilling cleaning fluid tank 175 with cleaning fluid such as water. Additives such as cleaning agents and detergents can also be added to the fluid for improved cleaning. Alternately, additional tanks (not shown) could be included in the housing 101 for an extended cleaning fluid supply or additives that could be mixed with the cleaning fluid supply. The unit 10 could include a pre-heater 280 (FIG. 6) disposed in proximity to the cleaning fluid tank 175 for pre-heating the cleaning fluid for improved cleaning performance. The pre-heater 280 (FIG. 6) would only be operative when the unit 10 is connected to a conventional source of electrical power such as household current. The pre-heated water remains at the desired temperature once disengaged from the pre-heater (FIG. 6) for the period of time required to wash the vehicle.

Referring now to FIG. 4, shown is helical fluid supply tube 118 that provides pressurized cleaning fluid from the cleaning fluid supply tank 175 located in base portion 100 to spray head 115. The helical fluid supply tube 118 enables the spray head 115 to traverse the entire length of the track while maintaining the pressurized fluid supply between the cleaning fluid supply tank 175 to spray head 115. This movement is best illustrated by the position of spray head 115 and the helical supply tube 118 towards the top of the track as opposed to the positions of spray head 115 and helical fluid supply tube 118 towards the lower end of post 110, designated as 115′ and 118′, respectively. The movement of spray head 115 along the track is designated as S and S′. As discussed, cleaning fluid supplied from cleaning fluid supply tank 175 is pressurized by a pump 260 (FIGS. 5 and 6) and pump motor 261 (FIGS. 5 and 6) arrangement located in base portion 100. An electrical power cable (not shown) is also embedded in the helical supply tube 118 for delivering electrical power to the electric motor (not shown) moving spray head 115 to move back and forth along the track.

Also seen in FIG. 4 are the positioning sensors 210, 212 for maintaining the unit 10 a distance X from the vehicle A as shown in FIG. 3. The sensors 210, 212 are embedded in the front wall of housing 101 above the steering wheel 150, 151 and servomotor 215. The sensor 210, 212 could be any suitable type of distance sensor known in the art including infrared, ultrasonic and radar sensors. For example, ultrasonic sensors present the ideal solution for non-contact position and distance measurement in industrial areas where environmental conditions such as dust, smoke or steam may affect the sensors. Objects consisting of a variety of materials can be detected regardless of color or shape to within millimeters. These sensors use very high frequencies that are outside of the human hearing audible range. For example, an ultrasonic sensor model no. UB1000-18GM75-I-V14 available from Pepperl+Fuches of Twinsburg, Ohio could be used. This ultrasonic sensor is programmable for sensing range from 90 millimeters to 1 meter. The sensor can also be programmed to have a narrow beam angle or a wide beam angle. This sensor can also advantageously be combined with additional sensors for greater accuracy in determining the distance to the vehicle A.

A first sensor 210 is located directly above a second sensor 212. Both sensors 210, 212 are vertically adjustable for different vehicle types. The first sensor 210 is purposely located at a height higher than the wheels on a typical vehicle such as an automobile. The second sensor 212 is purposely located at height below the top of the wheels. This configuration is to ensure that an accurate reading of distance information is made by the sensors 210, 212 before any distance correcting signals are provided to the servomotor 215 (FIGS. 5 and 6). Both of sensors 210, 212 must be in agreement as to the distance to the vehicle A or else no error correcting signal will be sent to the servomotor 215 (FIGS. 5 and 6). This is a very important feature which eliminates errant electrical control signals being sent to servomotor 215 (FIGS. 5 and 6) when the unit 10 is passing by the wheels of the vehicle A. For example, if there were only a single positioning sensor at height at or below the top of the vehicle wheel, the unit 10 could incorrectly be steered toward the vehicle because of faulty distance information taken at the gap between the wheel well and the wheel, or at the wheel itself which is generally more inboard than the exterior vertical body panels of the vehicle. With the addition of the second positioning sensor 212, this possibility is eliminated because of the requirement that the distance information must match between the sensors 210, 212 before a distance correcting electrical signal is sent to the servomotor 215 (FIGS. 5 and 6).

In another embodiment of the invention, sensors 210, 212 could be replaced with roller devices (not shown) extending from the unit 10 to maintain the distance X between the unit 10 and the vehicle A. The roller devices (not shown) would be required to maintain continuous contact with the vehicle A surfaces. If the unit 10 begins to move further from the vehicle than the distance X, sensors (not shown) mounted in the rollers (not shown) could be used to provide feedback information to the servomotor 215 (FIGS. 5 and 6) to maintain the unit 10 on the circumferential path P (FIG. 2).

Still referring to FIG. 4, the spherical guide member 170 is shown at the distal end of guide arm 150. Thus, it should be understood that as the spherical guide member 170 moves from one horizontal surface of a vehicle of a first height to a second horizontal surface of the vehicle of a second height, the spherical guide member 170 imparts the same movement to guide arm 150 causing it to follow the same movement. The sliding bracket 149 (FIG. 1) at the proximal end of the guide arm 150 not only attaches guide arm 150 to post 110, but allows the vertical movement of guide arm 150 relative to post 110. Simultaneously, the movement of guide arm 150 over the varying horizontal contours of vehicle A also causes the arcuate track portion 112 of the tract to make an identical vertical movement relative to post 110. The design of the track and the arcuate track portion 112 is seamless such that spray head 115 can transition from the lower portion of the track to the arcuate track portion 112 and then further to the guide arm 150 regardless of the position of guide arm 150 relative to post 110.

Still referring to FIG. 4 but also to FIG. 5, a portion of the steering wheel 150 can be seen beneath housing 101. The steering wheel 150 is located adjacent another steering wheel 151 being separated therebetween by a small gap. The steering wheels 150, 151 are mounted in a housing 155 and steered by a servomotor 215. The propulsion wheels 155, 156 are mounted on an axle 157. The axle 157 has a pair of pulleys 158 that are provided rotary power by a pair of belts 159. The pair of belts 159 are rotated by a pair of pulleys 160 rotated by propulsion motor 205. Propulsion motor 205 is energized when switch 215 is moved to the on position.

Referring now particularly to FIG. 5 shown is a cross-sectional view of the unit 10 taken along line 5-5 of FIG. 4 showing the various electrical components comprising electronic control system 200 (shown schematically in FIG. 6). In one embodiment of the invention, electronic control system 200 (FIG. 6) includes the rechargeable battery 250, a direct current propulsion motor 205, an electrical bus 270 for distributing power, and servomotor 215 for steering the unit 10 along the circumferential path P (FIG. 2). The positioning sensors 210, 212 previously shown in FIG. 4 are also part of the electronic control system 200.

Referring now to FIG. 6, shown is a schematic diagram of the electronic control system 200 of the autonomous vehicle washing and drying unit 10. An electrical bus 270 distributes electrical power to the propulsion motor 205, pump 260, positioning sensors 210, 212, servomotor 215, and spray head motor 230. Electrical power is provided to the electrical bus 270 from a rechargeable battery 250. In one embodiment of the invention, rechargeable battery 250 is a twelve volt battery. Thus, the electronic control system 200 is configured to operate on direct current at twelve volts. Still, the invention is not limited in this regard as one with ordinary skill in the art could design the electronic control system 200 to operate at a different voltage or with alternating current from an onboard alternating current source.

A power switch 215 selectively controls the electrical power being provided to electrical bus 270. Thus, when power switch 215 is switched to the on position, electrical bus 270 is energized. Accordingly, propulsion motor 205, pump 260, poritioning sensors 210, 212, servomotor 215, and spray head motor 230 are also energized. There is a fuse 106 between battery 250 and switch 215 which will short out in the case of current overload.

In one embodiment of the invention, a relay switch 231 is located on spray head motor 230 for reversing the polarity of the voltage applied to spray head motor 230 as spray head motor 230 traverses back and forth along the track (FIG. 4) and the guide arm 150 (FIG. 3). Relay switch 231 could be configured to be manually switched for changing the polarity of the voltage applied to spray head motor 230 by engaging projections (not shown) at the opposing ends of the track (FIG. 4) and guide arm 150 (FIG. 3) reverse the direction of travel of spray head motor 230. Still, the invention is not limited in this regard. The polarity of the voltage applied to spray head motor 230 could be reversed by sensors (not shown) located at the opposing ends of the track (FIG. 4) and guide arm 150 (FIG. 4) which signal switch 230 when it is desired to reverse the direction of travel of spray head motor 230.

The electrical power from electrical bus 270 provided to servomotor 215 is selectively controlled by positioning sensors 210, 212. Positioning sensors 210, 212 constantly determine distance information to vehicle A and input this information to servomotor 215. The distance information from positioning sensors 210, 212 must match or no error correcting signal will be sent to servomotor 215 to make any adjustments to steering wheels 150, 151. The ultrasonic sensor model no. UB1000-18GM75-I-V14 available from Pepperl+Fuchs of Twinsburg, Ohio previously described used as positioning sensors 210, 212 can be programed to compare distance information between sensors 210, 212 before outputting an error correcting signal to a control relay 213 controlling sevomotor 215. Only when positioning sensors 210, 212 are in mutual agreement that unit 10 has deviated from the distance X to vehicle A, and whether the deviation is greater that or less than the distance X, will appropriate steering corrections be made by servomotor 215 to steering wheels 150, 151. The steering corrections are made until positioning sensors 210, 212 again determine that unit 10 is at distance X from vehicle A.

Propulsion motor 205 and pump 260 are continuously energized when power switch 215 is moved to the on position. Propulsion motor 205 propels the unit 10 along the circumferential path P (FIG. 2) as guided by positioning sensors 210, 212, servomotor 215, and steering wheels 150, 151 until power switch 215 is moved to the off position. Similarly, pump 260 pressurizes cleaning fluid from the cleaning solution tank 175 provided to spray head 115 until cleaning solution tank 175 (FIG. 4) is empty or power switch 215 is moved to the off position. Pump 260 will continue to run dry even after cleaning solution tank 175 (FIG. 4) is empty. When pump 260 is run dry, a blast of air is generated which could be used for drying the vehicle A. Pump 260 will continue to operate in this manner until power switch 215 is moved to the off position.

The battery 250 is required to be re-charged before use by being connected to a source of electrical power such as conventional 120 vac household current. Accordingly, a battery charging circuit 275 is provided connected to a power connector 214 for connecting to the conventional source of 120 vac power. However, the invention is not limited in this regard as the battery charging circuit 275 could be designed to connect to other sources of electrical power. The unit 10 is connected to the 120 vac power source when not in use or sometime prior to use. It is envisioned that the unit 10 will be stored in the garage when not in use and plugged into a 120 vac receptacle located in the garage. A power supply for rectifying and transforming the 120 vac current to direct current at a voltage such as twelve volts could be built into the battery charging circuit 275. Electrical power from the power supply could be provided to a pre-heater 280 for heating the cleaning fluid in cleaning fluid tank 175 prior to use. The pre-heater 280 would only be energized when the battery charging circuit/power supply 275 is connected to the conventional 120 vac power source. Prior to use, the power connector 214 must be disconnected from the 120 vac or other power source.

In another embodiment of the invention, electrical power could be provided to electrical bus 270 by an electrical power source (not shown) that generates electrical power onboard unit 10. The electrical power source could include a fuel cell (not shown) which generates electrical power from hydrogen and oxygen. The electrical power source could also include a conventional electrical generator (not shown). The electrical generator (not shown) could be provided rotary power by a prime mover such as an engine fueled by fuels such as gasoline or ethanol. Alternately, electrical power could be provided to electrical bus 270 by a hybrid of battery 250 power and the electrical power source onboard unit 10.

In another embodiment of the invention, the electronic control system 200 could include a microprocessor (not shown) which could input the distance information from positioning sensor 210, 212 for further controlling the operation of the servomotor 215 controlling the steering wheels 150, 151. The microprocessor (not shown) could also be used to control the operation of the pump 260 and pump motor 261 arrangement, the recharging of battery 250, the heater (not shown) preheating the cleaning fluid in cleaning solution tank 175 if so equipped, and the electric motor (not shown) causing the spray head 115 to move back and forth along the track (FIG. 1). The use of a microprocessor (not shown) allows more flexibility to be designed into how and when these components function, either independently or in conjunction with one another. For example, the microprocessor (not shown) could be programmed to control the amount of pressure delivered by spray head 115 as a function of the distance X of unit 10 to vehicle A. The microprocessor could be programmed to allow the user to select the speed of the unit 10 as it circumscribes vehicle A and the length of the wash and drying cycles. The microprocessor (not shown) could be programmed to allow the user to pre-select the number of wash and dry cycles that are desired to be performed. There are many such possibilities for using a microprocessor (not shown) to control the operation of the unit 10 and all are intended to be within the scope of the invention without limitation.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. An apparatus for treating an exterior surface of a vehicle, comprising:
a motorized base portion;
a surface treating system mounted on said motorized base portion for treating an exterior surface of the vehicle; and
an electronic control system for autonomously guiding and propelling said base portion relative to said vehicle on a circumferential path around the vehicle.

2. The apparatus of claim 1, wherein said surface treating system includes at least one spray head delivering pressurized cleaning fluid to the exterior surface of the vehicle.

3. The apparatus of claim 2, wherein said at least one spray head moves along a track comprised of a vertical portion, an arcuate portion, and a horizontal portion.

4. The apparatus of claim 3, wherein said horizontal portion is varied in height by a spherical guide member disposed on a distal end of said horizontal portion, said spherical guide member being configured for being disposed on horizontal surfaces of said vehicle for varying the height of said horizontal portion for conforming the height of said horizontal portion to the height of said horizontal surfaces as said motorized base portion moves along said circumferential path around said vehicle, said horizontal portion of said track supporting said spray head over said horizontal surfaces for delivering pressurized cleaning fluid to the exterior surface of said vehicle.

5. The apparatus of claim 4, wherein said at least one spray head moves along said track, said spray head being movably mounted on said track by a pair of guide rollers, wherein at least one of said guide rollers is motorized by an electric motor for propelling said spray head back and forth along said track and allowing said spray head to seamlessly transition between said vertical portion, arcuate portion, and horizontal portions of said track.

6. The apparatus of claim 1, wherein said surface treating system includes at least one nozzle for directing pressurized air to the exterior surface of the vehicle for drying the vehicle.

7. The apparatus of claim 1, wherein said electronic control system includes at least one sensor for continuously determining distance information between said motorized base portion and said vehicle, said electronic control system using said distance information to provide error correcting signals to said motorized base portion to maintain said motorized base portion a predetermined distance from said vehicle as said motorized base portion is propelled on said circumferential path.

8. The apparatus of claim 7, wherein said predetermined distance is twelve inches.

9. The apparatus of claim 7, further including at least one wheel for steering said motorized base portion along said circumferential path, said at least one wheel being steered by a servomotor receiving said error correcting signals from said electronic control system.

10. The apparatus of claim 1, further including at least one wheel for propelling said motorized base portion on said circumferential path, said at least one wheel being provided rotary power by an electric motor.

11. The apparatus of claim 1, wherein said apparatus includes a power source.

12. The apparatus of claim 11, wherein said power source is a member of the group consisting of a rechargeable battery, fuel cell, and electrical generator.

13. The apparatus of claim 12, wherein said electrical generator is supplied rotary power by an engine fueled by a member of the group consisting of gasoline, ethanol, and a hybrid of gasoline and ethanol.

14. The apparatus of claim 1, further including one or more tanks for storing at least one fluid used in conjunction with the surface treating system.

15. The apparatus of claim 14, further including a pump for pressurizing said at least one fluid.

16. The apparatus of claim 14, further including a pre-heater for pre-heating cleaning fluid contained in said at least one or more of tanks.

17. A self contained, autonomous apparatus for washing and drying a vehicle, comprising;
a main body;
a track attached to the main body;
one or more tanks;
at least one spray head movably mounted on the track and fluidly connected to said one or more tanks, said spray head for delivering fluid stored in said one or more tanks to an exterior surface of the vehicle;
one or more sensors;
a propulsion system for propelling the main body along a circumferential path around said vehicle;
a pump for pressurizing said fluid;
an electronic control system; and
a power source for providing electrical power to said one or more sensors, said pump, said propulsion system, and said electronic control system;
wherein said one or more sensors continuously determines distance information between said main body and said vehicle, said one or more sensors continuously providing said distance information to said electronic control system for further providing error correcting signals to said propulsion system to maintain said main body on said circumferential path around said vehicle, said spray head systematically delivering fluid to the exterior surface of said vehicle.

18. The apparatus of claim 17, wherein said at least one spray head moves along a track comprised of a vertical portion, an arcuate portion, and a horizontal portion, said horizontal portion is varied in height by a spherical guide member disposed on a distal end of said horizontal portion, said spherical guide member being disposed on horizontal surfaces of said vehicle for varying the height of said horizontal portion for conforming the height of said horizontal portion to the height of said horizontal surfaces as said motorized base portion moves along said circumferential path around said vehicle, said horizontal portion of said track supporting said spray head over said horizontal surfaces for delivering said fluid to the exterior surface of said vehicle.

19. The apparatus of claim 17, wherein said at least one spray head is movably mounted on said track by a pair of guide rollers, wherein at least one of said guide rollers is motorized by an electric motor for propelling said spray head back and forth along said track, said guide rollers allowing said spray head to seamlessly transition between said vertical portion, arcuate portion, and horizontal portions of said track.

20. The apparatus of claim 17, wherein said power source is a member of the group consisting of a rechargeable battery, fuel cell, and electrical generator.
